(19) United States
(12) Patent Application Publication
(10) Pub. No.: US 2026/0056064 A1
(43) Pub. Date: Feb. 26, 2026

(54) TEMPERATURE DETECTING CIRCUIT, TEMPERATURE DETECTING METHOD, AND CIRCUIT BOARD

(71) Applicant: CANON KABUSHIKI KAISHA, Tokyo (JP)

(72) Inventor: YASUHIRO SOEDA, Kanagawa (JP)

(21) Appl. No.: 19/289,422

(22) Filed: Aug. 4, 2025

(30) Foreign Application Priority Data
Aug. 23, 2024 (JP) 2024-143406

(51) Int. Cl. G01K 7/00

(52) U.S. Cl. CPC G01K 7/00

(57) ABSTRACT

Provided is a temperature detecting circuit for printing element board including: one or more diode elements for detecting temperature of a printing element board; a terminal configured to receive, as an input, a voltage appearing at a first terminal of each of the diode elements; a connecting unit configured to electrically connect the first terminal and the terminal; and a capacitive element located close to the diode element and connected in parallel to the diode element.

### BACKGROUND

### Field of the Technology

The present disclosure relates to a temperature detecting circuit, a temperature detecting method, and a circuit board.

### Description of the Related Art

Printing apparatuses such as printers include a printing head that includes a plurality of nozzles arranged for ejecting printing agents such as ink. The printing head ejects printing agents by driving a printing element board based on print data corresponding to a print job received by the printing apparatus from an external device. The printing apparatus performs control to maintain appropriate temperature of the printing element board and printing agents for ejection operation of the printing agents by the printing element board.

Patent Literature 1 (Japanese Patent Laid-Open No. 2005-169867) discloses a technique of providing a diode for temperature detection on a printing element board, a technique of detecting temperature of the printing element board from a voltage of the diode, and a technique of drawing the voltage to the outside of the printing element board.

According to the method of Patent Literature 1, while it is possible to detect temperature of the printing element board by using a diode, a problem is that highly accurate temperature detection cannot be achieved due to electric noise generated in a circuit constituting the printing head.

### SUMMARY

A temperature detecting circuit for printing element board according to an aspect of the present disclosure includes: one or more diode elements for detecting temperature of a printing element board; a terminal configured to receive, as an input, a voltage appearing at a first terminal of each of the diode elements; a connecting unit configured to electrically connect the first terminal and the terminal; and a capacitive element located close to the diode element and connected in parallel to the diode element.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an example of a configuration of a printing apparatus;

FIG. 2 is a diagram illustrating an example of a configuration of the inside of a printing head;

FIG. 3 is a diagram illustrating an example of a configuration of a circuit of a printing element board;

FIG. 4 is a diagram illustrating an example of a configuration of a circuit of a temperature detecting unit;

FIGS. 5A and 5B are diagrams illustrating an example of a circuit included in the temperature detecting unit;

FIG. 6 is a diagram illustrating an example of a circuit of the printing element board;

FIG. 7 is a diagram illustrating an example of a configuration of a circuit of the temperature detecting unit;

FIG. 8 is a diagram illustrating an example of a circuit of the printing element board;

FIG. 9 is a diagram illustrating an example of a configuration of a circuit of the temperature detecting unit; and

FIG. 10 is a diagram illustrating an example of a circuit configuration of the inside of the printing head.

### DESCRIPTION OF THE EMBODIMENTS

Preferable embodiments of the present disclosure will now be described in detail with reference to the attached drawings. The embodiments described below are not intended to limit matters of the present disclosure, nor are all combinations of the features described in the embodiments described below necessarily essential to the solutions of the present disclosure. The same configurations will be described with the same reference signs given thereto.

### First Embodiment

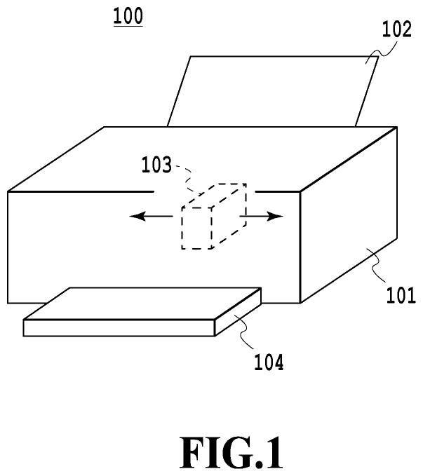

FIG. 1 is a perspective view illustrating an example of a configuration of a printing apparatus 100 in the embodiment. The printing apparatus 100 includes a main body unit 101, a paper feed tray 102, and a paper discharging tray 104. A printing head 103 is provided inside the main body unit 101.

The printing apparatus 100 feeds a printing medium (not illustrated) from the paper feed tray 102 to the main body unit 101. The printing medium fed to the main body unit 101 is conveyed toward the paper discharging tray 104 in a predetermined pattern of time and speed. Then, while reciprocating in the directions of arrows indicated in FIG. 1, the printing head 103 ejects printing agents such as ink onto the printing medium at an appropriate timing to accomplish print processing. Thereafter, printouts from the print processing are discharged onto the paper discharging tray 104. In the embodiment, the printing apparatus 100 is a printing apparatus with which printing is achieved by an ink jet system.

The printing apparatus 100, which moves a printing head in a direction intersecting with the direction in which the printing medium is discharged to accomplish print processing, is generally called a serial head printer. Other printing apparatuses include a line head printer with a printing head being immovable to accomplish print processing. The line head printer is different from the serial head printer in that it does not associate with reciprocal movement of the printing head during printing operation. Note that in the embodiment, both printing systems of a serial head type and a line head type are applicable to the printing apparatus 100.

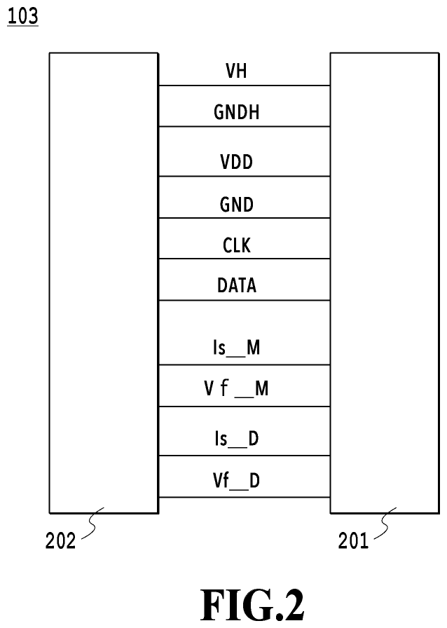

FIG. 2 is a block diagram illustrating an example of a configuration of the inside of the printing head 103. The printing head 103 includes a head board 201, which is a circuit board of the printing head 103, and a printing element board 202. The head board 201 and the printing element board 202 are connected together by a signal wiring line, a power source wiring line, and the like. The power is supplied from the head board 201 to the printing element board 202. The signal wiring line is used to transmit digital data and analog data as well as various signals between the head board 201 and the printing element board 202.

A power source wiring line VH is a wiring line for supplying heater power for causing ejection of printing agents fed to the printing element board 202. The heater power has, for example, a voltage of 24 V to 32 V. A reference voltage wiring line GNDH is a wiring line for providing a reference potential to the power source wiring line VH. The reference potential may be represented as a ground (GND).

A power source wiring line VDD is a wiring line for supplying operating power to operate a drive circuit located in the printing element board 202. The operating power has, for example, a voltage of 3.3 V. A reference voltage wiring line GND is a wiring line for providing a reference potential to the power source wiring line VDD.

A signal wiring line CLK and a signal wiring line DATA are each a wiring line for transmitting a control signal to control the operation of the printing element board 202. A wiring line Is_M and a wiring line Is_D are each a wiring line for causing a current to flow in a diode element for detecting temperature of the printing element board 202, which is provided in the printing element board 202. A wiring line Vf_M and a wiring line Vf_D are each a wiring line for outputting a voltage appearing at an anode terminal of the diode element toward the head board 201. The reference voltage wiring line GND is a wiring line for providing a reference potential to each of the wiring line Is_M, the wiring line Is_D, the wiring line Vf_M, and the wiring line Vf_D.

While in FIG. 2, the above-described wiring lines are each illustrated in a single wiring line, this is not a limitation. For example, in the case of power source wiring lines such as the power source wiring line VH and the power source wiring line VDD, a plurality of wiring lines of the same kind may be provided for the purpose of securing electric power (amplitude of current) supplied to the printing element board 202.

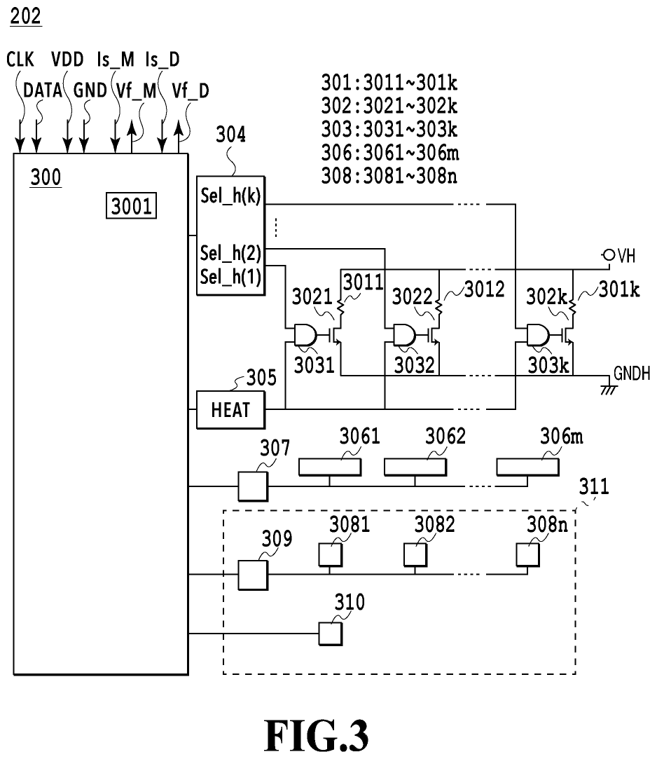

FIG. 3 is a diagram illustrating an example of a configuration of a circuit of the printing element board 202. The printing element board 202 includes a processor 300 and a plurality of circuits electrically connected to the processor 300. The printing element board 202 includes discharge elements 3011 to 301k, drive elements 3021 to 302k, and logic elements 3031 to 303k, as well as a first logic unit 304 and a second logic unit 305. The printing element board 202 includes heating elements 3061 to 306m, and a third logic unit 307. The printing element board 202 includes diode elements 3081 to 308n and 310, and a fourth logic unit 309.

In a case in which it is not necessary to make distinction, the discharge elements 3011 to 301k, the drive elements 3021 to 302k, and the logic elements 3031 to 303k are referred to as a discharge element 301, a drive element 302, and a logic element 303, respectively. Furthermore, in the specification, the notation rule is applicable to any other constituent elements.

The discharge element 301 operates to eject printing agents by being driven by the drive element 302 described later. A thermoelectric transducer is used for the discharge element 301. Each drive element 302 is connected in series to one corresponding discharge element 301. Any known switching element such as a metal-oxide-semiconductor (MOS) transistor is used for an individual drive element 302. Placed in electrical connection, the drive element 302 applies power to drive the discharge element 301 and stops the driving by being placed in non-electrical connection.

In the case of an MOS transistor, the drive element 302 is configured such that its gate terminal is connected to an output of the logic element 303 and a current path is formed between its drain terminal and its source terminal, which are connected to the discharge element 301, and provided on the printing element board 202.

For an input of the logic element 303, for example, an SEL_h (1) signal is input from the first logic unit 304 and an HEAT signal is input from the second logic unit 305 to the logic element 3031. Similarly, for other logic elements, an SEL_h (2) signal is input from the first logic unit 304 and an HEAT signal is input from the second logic unit 305 to the logic element 3032. Furthermore, an SEL_h (k) signal is input from the first logic unit 304 and an HEAT signal is input from the second logic unit 305 to the logic element 303k.

The heating elements 3061 to 306m are provided in predetermined positions of the printing element board 202 (for example, a position in which printing agents ejected by the discharge element 301 can sufficiently be heated). As in the discharge element 301, a thermoelectric transducer is used for each individual heating element 306. The third logic unit 307 drives the heating element 306 based on a control signal from the processor 300 to thereby regulate the temperature of the printing element board 202.

In the embodiment, a thermoelectric transducer is used for any of the discharge element 301 and the heating element 306. Note that the heating element 306 is also referred to as a sub-heater or a sub-heater element and distinguished from the discharge element 301. That is, the discharge element 301 is used to eject printing agents, whereas the heating element 306 is not directly used to eject printing agents.

The diode elements 3081 to 308n are each an element for detecting the temperature of the printing element board 202 and provided in a predetermined position of the printing element board 202 (for example, a position in which the temperature of the discharge element 301 can sufficiently be detected). The fourth logic unit 309 performs control to drive the individual diode element 308. In other words, the fourth logic unit 309 electrically connects an anode terminal of the individual diode element 308 to a terminal Vf_M connected to the wiring line Vf_M. Then, the fourth logic unit 309 outputs results of temperature detection at the individual diode element 308 to the processor 300 through the terminal Vf_M (not illustrated) provided to the processor 300. In this way, the processor 300 can receive results of temperature detection at the individual diode element 308 from the fourth logic unit 309.

The processor 300 performs control to drive each of the above-described elements by performing a predetermined calculation processing. Although described in detailed later, the processor 300 includes a processing unit 3001. The function of the processor 300 may be implemented by any of hardware and software.

The function of the diode element 310 is similar to that of the diode element 308. While the diode element 308 is connected to the processor 300 through the fourth logic unit 309, the diode element 310 is different from the diode element 308 in that it is connected directly to the processor 300. Hereinafter, the diode elements 308 and 310 and the fourth logic unit 309 are collectively referred to as a temperature detecting unit 311.

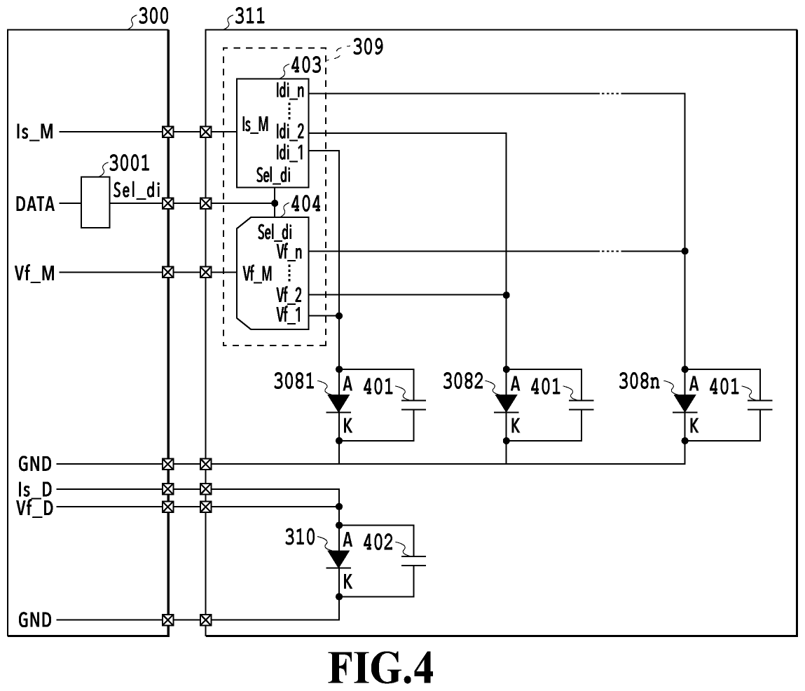

FIG. 4 is a diagram illustrating an example of a configuration of a circuit of the temperature detecting unit 311. The temperature detecting unit 311 constitutes a temperature detecting circuit for detecting the temperature of the printing element board 202. For simplification of the description, for example, the terminal name and the voltage indicative of an electric potential difference between the terminal and the ground will be indicated by the same reference sign as seen in a relationship between the terminal Vf_M and the voltage Vf_M. A current passing through the terminal, a control signal and data transmitted to the terminal, and the like will also be indicated by the same reference sign. In the embodiment, a voltage indicative of an electric potential difference between a predetermined terminal and the ground will be referred to as a voltage appearing at a predetermined terminal.

The temperature detecting unit 311 includes one or more diode elements 308. As illustrated in FIG. 4, the temperature detecting unit 311 in the embodiment includes one or morecapacitive elements 401. The capacitive element 401 is, for example, a capacitor and connected to two terminals of the diode element 308. That is, the capacitive element 401 is connected in parallel to the diode element 308. Furthermore, the capacitive element 401 is arranged in the vicinity of the diode element 308. The vicinity of the diode element 308 in the embodiment refers to being close to the diode element 308 to the extent that noise caused by the diode element 308 can be reduced. The capacitive element 401 is provided in a one-to-one manner with the diode element 308.

Each cathode terminal K of the diode elements 3081 to 308k is connected to the reference voltage wiring line GND. Furthermore, each anode terminal A of the diode element 308 is connected to the fourth logic unit 309.

The fourth logic unit 309 includes an analog switch 403 and an analog multiplexor 404. Each anode terminal A of the diode elements 3081 to 308k is connected to each output terminal of the analog switch 403 and connected to each input terminal of the analog multiplexor 404.

A diode selection signal Sel_di is input to an input terminal Sel_di of the analog switch 403. The diode selection signal Sel_di is a multi-bit signal and is a signal for controlling the analog switch 403 and the analog multiplexor 404 through a parallel interface or a serial interface.

The analog switch 403 outputs a diode current Is_M flowing from the processor 300 from one terminal of output terminals Idi_1 to Idi_n depending on a value of the diode selection signal Sel_di. At this time, the diode element 308 corresponding to the output terminal outputting the diode current Is_M allows a forward current to flow, so that a forward voltage appears at the anode terminal A depending on the temperature of the diode element 308. The diode current Is_M is a current with a predefined amplitude.

A signal similar to the diode selection signal Sel_di input to the input terminal Sel_di of the analog switch 403 is input to the input terminal Sel_di of the analog multiplexor 404. The analog multiplexor 404 outputs a forward voltage appearing at the anode terminal A of the diode element 308 corresponding to one terminal of input terminals Vf_1 to Vf_n from an output terminal Vf_M depending on a value of the diode selection signal Sel_di.

In their circuit configuration, the analog switch 403 and the analog multiplexor 404 select the same diode elements 3081 to 308n. Specifically, an output terminal Idi_1 of the analog switch 403 and an input terminal Vf_1 of the analog multiplexor 404 are connected to a diode element 3081. Then, each decoder that decodes the diode selection signal Sel_di described later selects an output terminal S_1 described later, so that the analog switch 403 and the analog multiplexor 404 select the diode element 3081. Other diode elements connected to each of the analog switch 403 and the analog multiplexor 404 have also a similar configuration.

Furthermore, a forward voltage applied to a diode element selected depending on a value of the diode selection signal Sel_di is output to the output terminal Vf_M of the analog multiplexor 404.

With selection information for a diode element being incorporated in a part of a DATA signal, it is possible to select any diode element from the outside of the printing element board 202. In this case, upon input of the DATA signal to the processing unit 3001 in the processor 300, the processing unit 3001 extracts selection information for a diode element from the DATA signal and generates the diode selection signal Sel_di.

The configurations of the diode element 310 and terminals Is_D and Vf_D are configurations similar to the diode element 308 and terminals Is_M and Vf_M, respectively. Note that the diode element 310 is different from the diode element 308 in that one diode element 310 is provided to terminals Is_D and Vf_D. That is, any circuit corresponding to the analog switch 403 and the analog multiplexor 404 is not connected to the diode element 310, leading to simplification of the circuit configuration and thereby making it possible to suppress noise resulting from the length of a wiring line of a circuit. In this way, it is possible to achieve highly reliable temperature detection.

In the embodiment, to suppress effects on temperature detection of noise caused by elements, circuits, and the like constituting the printing element board 202, a capacitive element is connected to the anode terminal A and the cathode terminal K of each diode element. Capacitive elements 401 and 402 each function to lower an AC impedance between the anode terminal A and the cathode terminal K of the diode elements 308 and 310. Accordingly, with the provision of the capacitive elements 401 and 402, it is possible to achieve decoupling against electric noise generated by the diode elements 308 and 310 or electric noise generated by circuits arranged near these elements. In this way, as compared to a case in which the capacitive elements 401 and 402 are not provided, it is possible to stabilize a voltage appearing at an anode terminal of a diode element. Accordingly, an effect of increasing the accuracy of temperature detection of the printing element board 202 can be expected.

Examples of electric noise include thermal noise caused by an element constituting the printing element board 202, noise resulting from switching operation, radiant noise caused by a wiring line for transmitting a signal.

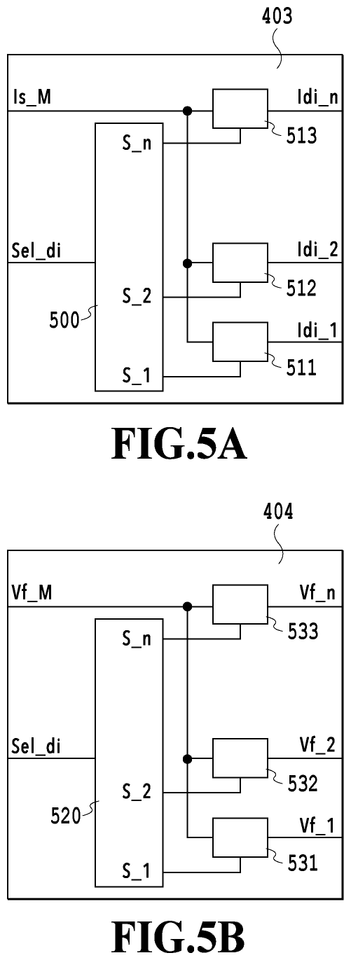

FIGS. 5A and 5B are diagrams illustrating an example of a circuit included in the temperature detecting unit 311. Specifically, FIG. 5A is a diagram for describing the analog switch 403 in detail, and FIG. 5B is a diagram for describing the analog multiplexor 404 in detail.

First, the analog switch 403 will be described. The analog switch 403 includes a decoder 500 and a plurality of switches 511 to 513. Hereinafter, in a case in which it is not necessary to distinguish individual switches, the switches 511 to 513 are collectively referred to as a switch 510. The same applies to a plurality of switches 531 to 533 described later. The decoder 500 selects one of output terminals S_1 to S_n depending on a value of the input diode selection signal Sel_di. In the embodiment, selection of one of the output terminals S_1 to S_n by the decoder 500 is referred to as placing an output terminal in a selected state.

One of the output terminals S_1 to S_n is exclusively assigned to each switch 510. That is, the decoder 500 performs control to place a switch, which is assigned to the output terminal that is in a selected state, in electrical connection by placing one of the output terminals S_1 to S_n in a selected state. For example, in a case in which the decoder 500 keeps an output terminal S_2 in a selected state depending on a value of the diode selection signal Sel_di, a switch 512 connected to a terminal Idi_2 is selected. As a result, a current flowing from the input terminal Is_M is output from the output terminal Idi_2.

The analog multiplexor 404 will be described in terms of the difference from the analog switch 403. A decoder 520 corresponds to the decoder 500, and a switch 530 corresponds to the switch 510. The output terminals S_1 to S_n of the decoder 520 of the analog multiplexor 404 are the same as those of the analog switch 403. For example, at a timing at which the output terminal S_2 is selected in the analog multiplexor 404, the output terminal S_2 is selected also in the analog switch 403.

The decoder 520 of the analog multiplexor 404 places one switch of the switch 530 in electrical connection. Then, the analog switch 403 outputs a voltage appearing at the anode terminal A of the diode element corresponding to the input terminal Vf connected to the switch that is in electrical connection from the output terminal Vf_M. For example, in a case in which the output terminal S_2 is selected depending on a value of the diode selection signal Sel_di, a switch 532 connected to the input terminal Vf_2 is placed in electrical connection. As a result, a voltage appearing at the anode terminal A of the diode element 3082 corresponding to the input terminal Vf_2 is output to the output terminal Vf_M. Then, the processor 300 can obtain a value indicative of a voltage that is a difference between a potential at the anode terminal A of the diode element 308 and a potential at the cathode terminal K of the diode element 308 (for example, a reference potential). In this way, the processor 300 can derive the temperature of the printing element board 202 based on the obtained value of voltage, the value of current Is_M with a predefined amplitude, and the like.

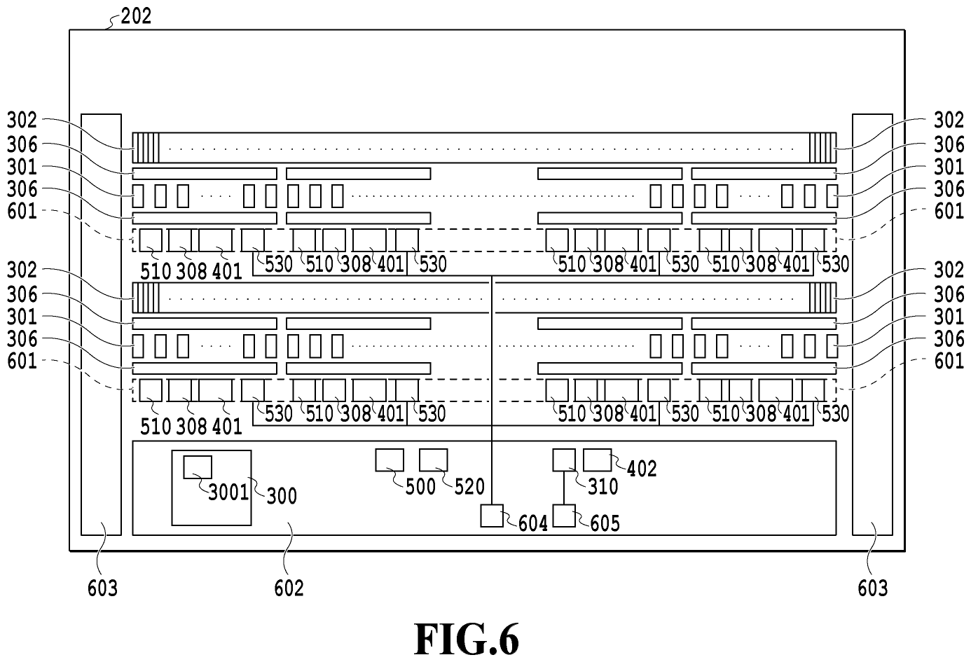

FIG. 6 is a diagram illustrating an example of a circuit of the printing element board 202. Specifically, FIG. 6 is a diagram illustrating an example of the constituent elements and the like included in the temperature detecting unit 311 arranged on the printing element board 202. Similar configurations will be given the same reference signs. Note that for simplification of the description, not all the wiring lines in the circuit of the printing element board 202 are indicated in FIG. 6.

The discharge element 301 is arranged on the printing element board 202, and a plurality of such elements is spaced at a certain interval in the left-right direction of FIG. 6. In the embodiment, this will be referred to as a discharge element row. Since the discharge element row is essentially the same as the discharge element 301, the discharge element row will be given the same number as the discharge element row 301. The numbering rule is similarly applicable to the drive element 302, the heating element 306, and the like.

One heating element row 306 is arranged above the discharge element row 301 in FIG. 6 and another one below. The heating element row 306 extends in the left-right direction of FIG. 6 arranged with a certain length in a divided way. The two rows of heating element row 306 arranged across the discharge element row 301 in the up-down direction of FIG. 6 are arranged over a plurality of discharge elements 301 in the left-right direction of FIG. 6 and divided at the same location in the left-right direction of FIG. 6. Furthermore, the two rows of heating element row 306 are electrically connected to each other and operate as one heating element. Of two rows of heating element row 306, in the embodiment, the heating element row arranged at the upper position in FIG. 6 will be referred to as an upper heating element row, and the heating element row arranged at the lower position in FIG. 6 will be referred to as a lower heating element row.

In FIG. 6, a drive element row 302 is arranged at a position above the upper heating element row 306. The drive element row 302 is arranged at the same density of arrangement as the discharge element row 301 in the left-right direction of FIG. 6 and arranged to be paired with the discharge element row 301.

Although not illustrated, a logic element row 303 is arranged at the same density of arrangement as the drive element row 302 in the left-right direction of FIG. 6 and arranged to be paired with the drive element row 302. The logic element row 303 may be arranged in the vicinity of the drive element row 302, extending in the left-right direction of FIG. 6. Specifically, of two rows of drive element row 302 in FIG. 6, the logic element row 303 may be arranged at a position above the upper drive element row 302, or may be arranged above the lower drive element row 302 and at a position below a circuit row 601 described later.

In FIG. 6, the circuit row 601 is arranged at a position below the lower heating element 306, extending in the left-right direction. The diode element 308, the capacitive element 401, the switch 510, and the switch 530 are arranged in the circuit row 601. The circuit row 601 is arranged in the left-right direction of FIG. 6, divided in the same division as the heating element row 306, and arranged to be paired with the heating element row 306. This means that the number of arranged elements m of the heating element 306 and the number of arranged elements n of the diode element 308 are equal. This is an example of design of the printing element board 202. The circuit row 601 may include any not-illustrated circuit arranged therein and, for example, a drive element for the heating element 306 is included in this case.

In the printing element board 202, the heating element row 306, the drive element row 302, and the circuit row 601 are considered as one unit relative to the position of arrangement of the discharge element row 301, and a plurality of rows of the unit may be provided in the up-down direction of FIG. 6. As described above, FIG. 6 is an example in which two rows of the heating element row 306 are provided on the printing element board 202.

In FIG. 6, an end-portion circuit 602 is arranged at the bottom of the printing element board 202. In the end-portion circuit 602, circuits that are not arranged in the circuit row 601 are arranged. For example, the processor 300, the processing unit 3001 in the processor 300, the decoders 500 and 520, the diode element 310, capacitive element 402, and pads 604 and 605 are arranged in the end-portion circuit 602. The pads 604 and 605 are provided to draw the terminal Vf_M and the terminal Vf_D provided to the processor 300 to the outside of the printing element board 202, respectively. An output terminal of the switch 530 arranged on the printing element board 202 is connected to the pad 604. Each output of the switch 530 is in a direct electrical contact with the switch 530 up to the pad 604. The pad 605 is electrically connected to the anode terminal A of the diode element 310 in a one-to-one manner.

In FIG. 6, wiring areas 603 are secured to the left and right of the printing element board 202. The wiring areas 603 are each used as an electric wiring area between the end-portion circuit 602 and the circuit row 601 and allow some circuits of the end-portion circuit 602 to be arranged.

Wiring lines of not-illustrated circuits may be formed in any way by using contact vias for electrically connecting layer to layer between polysilicon layers and metal line layers stacked on the printing element board 202. According to the circuit arrangement illustrated in FIG. 6, the printing element board including the capacitive elements 401 and 402 can be implemented. In the embodiment, while an example in which a diode is used as an element for detecting the temperature of the printing element board 202 has been described, any element may be applied insofar as the element has a temperature characteristic. For example, a resistance temperature detector may be applied as an element for detecting temperature.

In the embodiment, a capacitance that appears in a well structure (N-well or the like) on the substrate may be applied as a capacitive element, by utilizing it as such an element. Furthermore, the capacitive element may be implemented by providing a metal-insulator-metal (MIM) structure and the like. A capacitance in the form of a well structure can be fabricated by a mask set for fabricating typical transistors. Capacitive elements of an MIM structure have features such as providing ability to produce elements with a relatively large capacitance and ability to stabilize the capacitance against temperature variation of the printing element board 202 and variation in voltage of the circuit.

According to the embodiment, it is possible to suppress noise and detect temperature with high accuracy by providing a capacitive element to connect to the anode terminal A and the cathode terminal K of a diode element in parallel to the diode element. Furthermore, as illustrated in FIGS. 4 and 6 and other figures, the diode element 308 and the capacitive element 401 are arranged such that they are close to each other, so that noise caused by the diode element can be locally suppressed.

Accordingly, an effect of reducing effects of the noise on the entire printing element board 202 can be expected.

### Second Embodiment

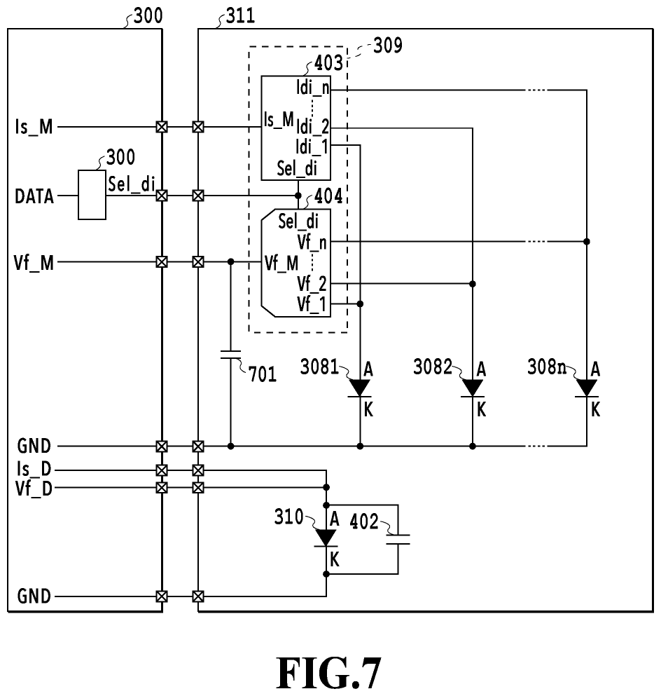

FIG. 7 is a diagram illustrating an example of a circuit of the temperature detecting unit 311 in the embodiment. In the embodiment, the temperature detecting unit 311 includes the diode element 308. That is, the embodiment is different from the first embodiment in that any element corresponding to the capacitive element 401 is not connected to the diode element 308 in the embodiment. On the other hand, in the embodiment, a capacitive element 701 is arranged between a wiring line for connecting the output terminal Vf_M of the analog multiplexor 404 with the terminal Vf_M provided to the processor 300 and a wiring line connected to a terminal for providing GND. The capacitive element 701 in the embodiment functions to lower an AC impedance between the output terminal Vf_M of the analog multiplexor 404 and the terminal for providing GND. Accordingly, with the provision of the capacitive element 701, it is possible to achieve decoupling against electric noise generated by the diode elements 308 and 310 and circuits arranged near these elements. Then, as compared to a case in which the capacitive element 701 is not provided, it is possible to stabilize a voltage appearing at the output terminal Vf_M. In this way, an effect of increasing the accuracy of temperature detection of the printing element board 202 can be expected.

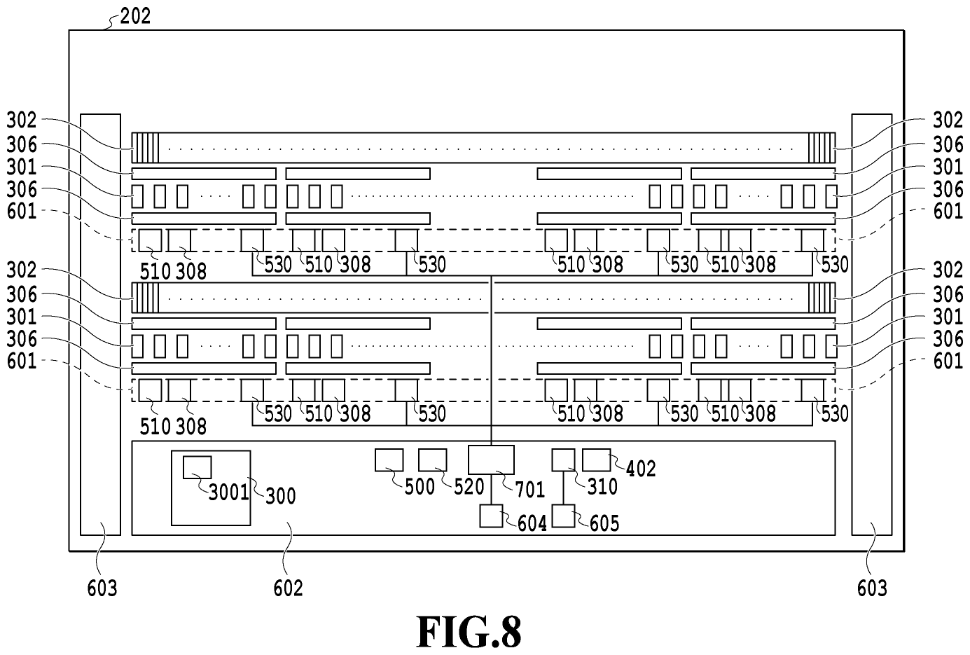

FIG. 8 is a diagram illustrating an example of a circuit of the printing element board 202 in the embodiment. Specifically, FIG. 8 is a diagram illustrating an example of elements and circuits illustrated in FIG. 7 arranged on the printing element board 202. The basic configuration of circuits on the printing element board 202 in the embodiment is the same as that of the first embodiment. Those configurations similar to those illustrated in FIG. 6 will be given the same reference signs and the description will not be repeated.

In FIG. 8, unlike the circuit configuration of the first embodiment, the capacitive element 401 is not arranged in the circuit row 601. On the other hand, the capacitive element 701 is arranged in the end-portion circuit 602. With the adoption of the circuit configuration as illustrated in FIG. 7, it is possible to simplify circuits on the printing element board 202. Furthermore, arranging the capacitive element 701 in the end-portion circuit 602 produces advantages described below.

As can be seen in FIG. 7, the area of the circuit row 601 is affected by the density of arrangement of elements in the element row arranged near the circuit row 601, so that constraints on arrangement of the capacitive element are large. On the other hand, the area of the end-portion circuit 602 is less likely to be affected by the element row arranged near the end-portion circuit 602, so that constraints on arrangement of the capacitive element are small. That is, the circuit configuration in the embodiment makes it possible to use a larger capacitance of the capacitive element 701, so that it is expected that a voltage appearing at the output terminal Vf_M of the analog multiplexor 404 is further stabilized. Accordingly, for example, noise with lower frequency components can be reduced. In this way, it is possible to achieve highly accurate temperature detection of the printing element board 202.

### Third Embodiment

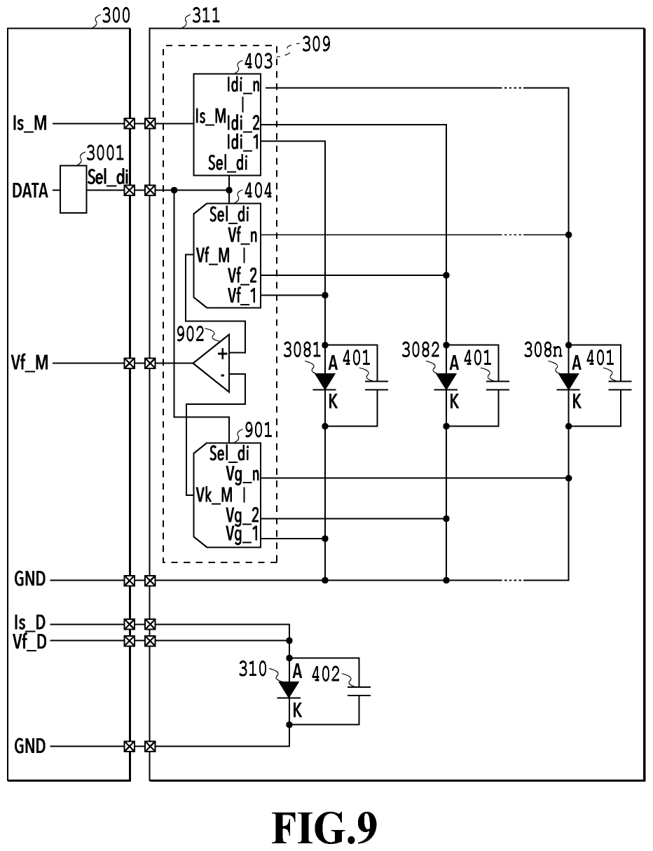

FIG. 9 is a diagram illustrating an example of a circuit of the temperature detecting unit 311 in the embodiment. In the embodiment, as in the first embodiment, the capacitive elements 401 and 402 are connected in parallel to the diode elements 308 and 310, respectively. The embodiment is different from the first embodiment in that an analog multiplexor 901 that has a configuration similar to the analog multiplexor 404 and a differential amplifier 902 connected to output terminals of the multiplexors are included.

A voltage appearing at the anode terminal A of the diode element 308 is output from the output terminal Vf_M through the analog multiplexor 404. Furthermore, a voltage appearing at the cathode terminal K of the diode element 308 is output from an output terminal Vk_M through the analog multiplexor 901. A voltage appearing at the output terminal Vf_M and a voltage appearing at output terminal Vk_M are input to a positive terminal (+) and a negative terminal (−) of the differential amplifier 902, respectively. The differential amplifier 902 outputs a difference between the voltage input to the positive terminal (+) and the voltage input to the negative terminal (−) and outputs a voltage of the difference to the terminal Vf_M of the processor 300.

As illustrated in FIG. 9, with the adoption of a circuit configuration in which the difference between a voltage appearing at the anode terminal A of the diode element 308 and a voltage appearing at the cathode terminal K of the diode element 308 is output to the terminal Vf_M, it is advantageous that noise of in-phase (common mode) components can be reduced.

Furthermore, possible circuit configurations for adoption for the diode element 310 include a configuration in which the anode terminal A of the diode element 310 and the cathode terminal K of the diode element 310 are each connected to a differential amplifier provided to the processor 300. Other possible circuit configurations include a configuration in which the anode terminal A of the diode element 310 and the cathode terminal K of the diode element 310 are each drawn to the outside of the printing element board 202 and connected to a differential amplifier provided to the head board 201, for example.

According to the embodiment, an effect of reducing noise of in-phase components out of electric noise generated in wiring lines up to the differential amplifier 902 can be expected. With the adoption of a differential amplifier, a similar effect can be expected for the diode element 310. Bringing wiring lines for the anode terminal A and the cathode terminal K as close as possible to each other to form parallel wiring lines makes it possible to increase the ratio of common mode components in the above-described electric noise, and therefore a noise cancellation effect increases.

In the circuit configuration illustrated in FIG. 9, in combination with effects produced by the capacitive elements 401 and 402, it is expected that a voltage output at the terminal Vf_M is further stabilized. As described above, the analog multiplexor 901 has a circuit configuration similar to the analog multiplexor 404. Furthermore, it is possible to implement the printing element board 202 illustrated in FIG. 9 by arranging a switch group including a switch (not illustrated) of the analog multiplexor 901 in the circuit row 601 and arranging a decoder group and the differential amplifier 902 in the end-portion circuit 602.

### Fourth Embodiment

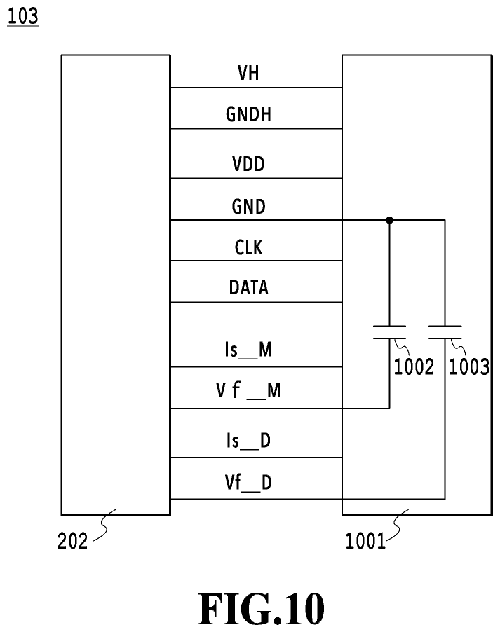

FIG. 10 is a diagram illustrating an example of a circuit configuration of the inside of a printing head in the embodiment. Specifically, FIG. 10 is a diagram illustrating a head board 1001 in the embodiment and the printing element board 202. As illustrated in FIG. 10, a capacitive element 1002 is provided between the reference voltage wiring line GND and the wiring line Vf_M of the head board 1001 and a capacitive element 1003 is provided between the reference voltage wiring line GND and the wiring line Vf_D. In addition to utilizing the circuit configurations described in the first embodiment to the third embodiment, the printing element board 202 may be made up of the printing element board 202 that does not include the capacitive elements 401, 402, and 701, and the differential amplifier 902 at all.

In the configuration illustrated in FIG. 10, the capacitive element 1002 and the capacitive element 1003 function to lower wiring line AC impedances appearing in the wiring line Is_M and the wiring line Is_D, respectively. Accordingly, with the provision of the capacitive element 1002 and the capacitive element 1003, it is possible to achieve decoupling against electric noise generated in the wiring line Is_M and the wiring line Is_D. Then, as compared to a case in which the capacitive elements 1002 and 1003 are not provided, it is possible to stabilize a voltage appearing at the anode terminal A of a diode element. In this way, an effect of increasing the accuracy of temperature detection of the printing element board 202 can be expected.

With the provision of the capacitive element 1002 and the capacitive element 1003 on the head board 1001, it is possible to provide a capacitive element that has a larger capacitance than other embodiments. Furthermore, it is possible to provide a plurality of capacitive elements, each of which has a different size of capacitance or accumulates electric charges in a different way, in parallel (for example, parallel connection of a 100 μF electrolytic capacitor and a 0.1 μF ceramic capacitor).

### Other Embodiments

The arrangements of capacitive elements and differential amplifiers are not limited to the arrangements described in the embodiment above. That is, it is possible to arrange the capacitive element and the differential amplifier on the printing element board or the head board in any way insofar as the accuracy of temperature detection of the printing element board can be increased. Furthermore, it is possible to combine arrangements of the capacitive element and the differential amplifier described above in any way.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-143406, filed Aug. 23, 2024, which is hereby incorporated by reference herein in its entirety.

What is claimed is:

1. A temperature detecting circuit for printing element board, comprising:
one or more diode elements for detecting temperature of a printing element board;
a terminal configured to receive, as an input, a voltage appearing at a first terminal of each of the diode elements;
a connecting unit configured to electrically connect the first terminal and the terminal; and
a capacitive element located close to the diode element and connected in parallel to the diode element.

2. The temperature detecting circuit for printing element board according to claim 1, wherein the capacitive element is provided in a one-to-one manner with the diode element.

3. The temperature detecting circuit for printing element board according to claim 2, wherein the connecting unit includes: an analog switch configured to perform control, based on a selection signal for selecting one of the diode elements, to output a current with a predefined amplitude to a first terminal of the selected diode element; and a first analog multiplexor configured to perform control to output a voltage appearing at the first terminal of the selected diode element.

4. A temperature detecting circuit for printing element board, comprising:
one or more diode elements for detecting temperature of a printing element board;
a terminal configured to receive, as an input, a voltage appearing at a first terminal of each of the diode elements;
a connecting unit configured to electrically connect the first terminal and the terminal, wherein
the connecting unit includes an analog switch configured to perform control, based on a selection signal for selecting one of the diode elements, to output a current with a predefined amplitude to a first terminal of the selected diode element, and a first analog multiplexor configured to perform control to output a voltage appearing at the first terminal of the selected diode element; and
a capacitive element connected to an output terminal of the first analog multiplexor and a terminal for providing a reference potential.

5. The temperature detecting circuit for printing element board according to claim 4, wherein the connecting unit further includes:
a second analog multiplexor configured to perform control to output a voltage appearing at a second terminal of the selected diode element; and
a differential amplifier configured to output a voltage of a difference between a voltage output from the first analog multiplexor and a voltage output from the second analog multiplexor.

6. The temperature detecting circuit for printing element board according to claim 5, wherein the capacitive element is located close to the diode element and connected in parallel to the diode element.

7. A temperature detecting method for printing element board, comprising
using a temperature detecting circuit for printing element board including:
one or more diode elements for detecting temperature of a printing element board;
a terminal configured to receive, as an input, a voltage appearing at a first terminal of each of the diode elements;
a connecting unit configured to electrically connect the first terminal and the terminal; and
a capacitive element located close to the diode element and connected in parallel to the diode element, and
detecting temperature of the printing element board based on a voltage input to the terminal.

8. A circuit board for temperature detection for a printing element board, the circuit board comprising a capacitive element connected to:
a wiring line connected to a temperature detecting circuit for printing element board, wherein the temperature detecting circuit for printing element board includes
one or more diode elements for detecting temperature of the printing element board,
a terminal configured to receive, as an input, a voltage appearing at a first terminal of each of the diode elements,
a connecting unit configured to electrically connect the first terminal and the terminal, and
a capacitive element located close to the diode element and connected in parallel to the diode element, the wiring line being connected to the terminal; and
a wiring line providing a reference potential.
